(19) United States
(12) Patent Application Publication
(10) Pub. No.: US 2025/0190329 A1
(43) Pub. Date: Jun. 12, 2025

(54) SYSTEM AND METHOD FOR DEBUGGING IN HARDWARE

(71) Applicant: Samsung Electronics Co., Ltd., Suwon-si (KR)

(72) Inventors: Da ZHANG, Fremont, CA (US); Tong ZHANG, Fremont, CA (US); Changhee JUNG, West Lafayette, IN (US); Rekha PITCHUMANI, Oak Hill, VA (US); Yang Seok KI, Palo Alto, CA (US)

(21) Appl. No.: 18/613,035

(22) Filed: Mar. 21, 2024

Related U.S. Application Data
(60) Provisional application No. 63/608,149, filed on Dec. 8, 2023.

(51) Int. Cl. G06F 11/36; G06F 12/1045

(52) U.S. Cl. CPC G06F 11/3648; G06F 11/3698; G06F 12/1045

(57) ABSTRACT

A system and method for debugging in hardware. In some embodiments, the system includes a processor, the processor including: a first memory configured to store an instruction; and a second memory configured to store a breakpoint bit, for the instruction, the processor being configured to: determine that the breakpoint bit is set, and based on determining that the breakpoint bit is set, to report an error.

### CROSS-REFERENCE TO RELATED APPLICATION(S)

The present application claims priority to and the benefit of U.S. Provisional Application No. 63/608,149, filed Dec. 8, 2023, entitled “Architecture Support for More Hardware Debug Registers”, the entire content of which is incorporated herein by reference.

### FIELD

One or more aspects of embodiments according to the present disclosure relate to computing systems, and more particularly to systems and methods for debugging.

### BACKGROUND

When developing or modifying software for a computing system, errors may be inadvertently introduced into the software. Such errors may, on occasion, be primarily detectable by the observation of incorrect behavior in the software, and determining the mechanisms causing the incorrect behavior, for example, identifying the error in the code, may be challenging.

It is with respect to this general technical environment that aspects of the present disclosure are related.

### SUMMARY

According to an embodiment of the present disclosure, there is provided a system, including: a processor, the processor including: a first memory configured to store an instruction; and a second memory configured to store a breakpoint bit, for the instruction, the processor being configured to: determine that the breakpoint bit is set, and based on determining that the breakpoint bit is set, to report an error.

In some embodiments, the first memory includes a first portion of a level one cache, and the second memory includes a second portion of the level one cache.

In some embodiments, the processor includes a first memory management unit configured to: convert a virtual address of the instruction to a first physical address; and load the instruction from the first physical address into the first memory.

In some embodiments, the processor includes a second memory management unit configured to: convert a virtual address of the breakpoint bit to a second physical address; and load the breakpoint bit from the second physical address into the second memory.

In some embodiments: the processor includes a second memory management unit configured to convert a virtual address of the breakpoint bit to a second physical address; the processor includes an address conversion cache for breakpoint bits; and the converting of the virtual address of the breakpoint bit to a second physical address includes converting the virtual address of the breakpoint bit to the second physical address based on data stored in the address conversion cache for breakpoint bits.

In some embodiments: the processor includes a second memory management unit configured to convert a virtual address of the breakpoint bit to a second physical address; and the processor is further configured to: determine that debug mode is enabled; and based on determining that debug mode is enabled, load the breakpoint bit from the second physical address into the second memory.

In some embodiments: the processor includes a second memory management unit configured to convert a virtual address of the breakpoint bit to a second physical address; and the processor is further configured to: determine, based on a debug control register of the processor, that debug mode is enabled; and based on determining that debug mode is enabled, load the breakpoint bit from the second physical address into the second memory.

According to an embodiment of the present disclosure, there is provided a method, including: storing an instruction in a first memory of a processor; storing a breakpoint bit, for the instruction, in a second memory of the processor; determining, by the processor, that the breakpoint bit is set; and in response to determining that the breakpoint bit is set, report an error.

In some embodiments, the first memory is a first portion of a level one cache, and the second memory is a second portion of the level one cache.

In some embodiments, the processor includes a first memory management unit, and the method further includes: converting, by the first memory management unit, a virtual address of the instruction to a first physical address; and loading, by the first memory management unit, the instruction from the first physical address into the first memory.

In some embodiments, the processor includes a second memory management unit, and the method further includes: converting, by the second memory management unit, a virtual address of the breakpoint bit to a second physical address; and loading, by the second memory management unit, the breakpoint bit from the second physical address into the second memory.

In some embodiments: the processor includes a second memory management unit; the method further includes converting, by the second memory management unit, a virtual address of the breakpoint bit to a second physical address; the processor includes an address conversion cache for breakpoint bits; and the converting of the virtual address of the breakpoint bit to a second physical address includes converting the virtual address of the breakpoint bit to the second physical address based on data stored in the address conversion cache for breakpoint bits.

In some embodiments: the processor includes a second memory management unit; and the method further includes: converting, by the second memory management unit, a virtual address of the breakpoint bit to a second physical address; determining, by the processor that debug mode is enabled; and based on determining that debug mode is enabled, loading the breakpoint bit from the second physical address into the second memory.

In some embodiments: the processor includes a second memory management unit; and the method further includes: converting, by the second memory management unit, a virtual address of the breakpoint bit to a second physical address; determining, by the processor, based on a debug control register of the processor, that debug mode is enabled; and based on determining that debug mode is enabled, loading the breakpoint bit from the second physical address into the second memory.

According to an embodiment of the present disclosure, there is provided a system, including: a processing circuit; and a memory, wherein: the memory stores: an instruction; and a breakpoint bit, for the instruction; and the processing circuit is configured to: determine that the breakpoint bit is set, and in response to determining that the breakpoint bit is set, to report an error.

In some embodiments, the memory is a level one cache.

In some embodiments, the processing circuit includes a first memory management unit configured to: convert a virtual address of the instruction to a first physical address; and load the instruction from the first physical address into the memory.

In some embodiments, the processing circuit includes a second memory management unit configured to: convert a virtual address of the breakpoint bit to a second physical address; and load the breakpoint bit from the second physical address into the memory.

In some embodiments: the processing circuit includes a second memory management unit configured to convert a virtual address of the breakpoint bit to a second physical address; the processing circuit includes an address conversion cache for breakpoint bits; and the converting of the virtual address of the breakpoint bit to a second physical address includes converting the virtual address of the breakpoint bit to the second physical address based on data stored in the address conversion cache for breakpoint bits.

In some embodiments: the processing circuit includes a second memory management unit configured to convert a virtual address of the breakpoint bit to a second physical address; and the processing circuit is further configured to: determine that debug mode is enabled; and based on determining that debug mode is enabled, load the breakpoint bit from the second physical address into the memory.

### BRIEF DESCRIPTION OF THE DRAWINGS

These and other features and advantages of the present disclosure will be appreciated and understood with reference to the specification, claims, and appended drawings wherein:

FIG. 1A is a block diagram of a host and a storage device, according to an embodiment of the present disclosure;

FIG. 1B is a system level block diagram, according to an embodiment of the present disclosure;

FIG. 2 is a hybrid block diagram and flow chart of the structure and operation of a portion of a host processor, according to an embodiment of the present disclosure;

FIG. 3, is a block diagram showing the storage and management of breakpoint bits and instructions, according to an embodiment of the present disclosure;

FIG. 4 is a flow chart of a method for responding to debug bit enablement, according to an embodiment of the present disclosure;

FIG. 5A is a first portion of a flowchart of a method, according to an embodiment of the present disclosure; and

FIG. 5B is a second portion of a flowchart of a method, according to an embodiment of the present disclosure.

### DETAILED DESCRIPTION

The detailed description set forth below in connection with the appended drawings is intended as a description of exemplary embodiments of systems and methods for debugging provided in accordance with the present disclosure and is not intended to represent the only forms in which the present disclosure may be constructed or utilized. The description sets forth the features of the present disclosure in connection with the illustrated embodiments. It is to be understood, however, that the same or equivalent functions and structures may be accomplished by different embodiments that are also intended to be encompassed within the scope of the disclosure. As denoted elsewhere herein, like element numbers are intended to indicate like elements or features.

Debug mode in a central processing unit (CPU) may allow debugging to be performed more efficiently than in normal operating mode. In debug mode, a central processing unit may, during operation, compare the contents of various central processing unit registers to the contents of various corresponding debug registers, and report an error (for example, raise an exception) if the contents of any register match the contents of the corresponding debug register. Examples of registers for which such feature may be available include the program counter, and registers in which addresses (for use in load and store instructions) are stored. This may make it possible for the central processing unit to raise an exception when a particular instruction is executed, or when a particular memory address is accessed.

In some aspects, the number of debug registers is limited and may be relatively small. This may be an obstacle to efficient debugging if, for example, a large number of instructions in the executable code are potentially associated with anomalous execution of the software being debugged.

As such, in some embodiments, the disclosed systems can implement breakpoints, for example, based on program counter values by associating with each instruction a breakpoint bit that when set (for example, when equal to one) causes the central processing unit to report an error (for example, raise an exception) when the corresponding instruction is executed and when not set (for example, when equal to zero) to execute the corresponding instruction without reporting an error.

In some respects, the breakpoint bits may be stored (i) in a file in nonvolatile storage (for example, in the same file as the executable code, or in a separate file, associated with the executable code), and loaded into main memory when the software is loaded for execution. When a portion of the executable code is loaded into an instruction cache (I-cache) in the central processing unit, the corresponding portion of the breakpoint file may also be loaded into a cache in the central processing unit (for example, into a portion of the I-cache allocated for breakpoint bits).

As execution progresses, when the value of the program counter changes, a new instruction may be loaded from the instruction cache, and the corresponding breakpoint bit may be tested (for example, compared to one). If the bit is set, then the central processing unit may raise an exception; otherwise, execution may proceed normally.

In such an embodiment, the number of program counter values for which an exception will be raised is not limited to a small, fixed number as in some aspects. Instead, in such an embodiment, it is possible to associate a breakpoint with an arbitrary number of the instructions in a piece of executable code.

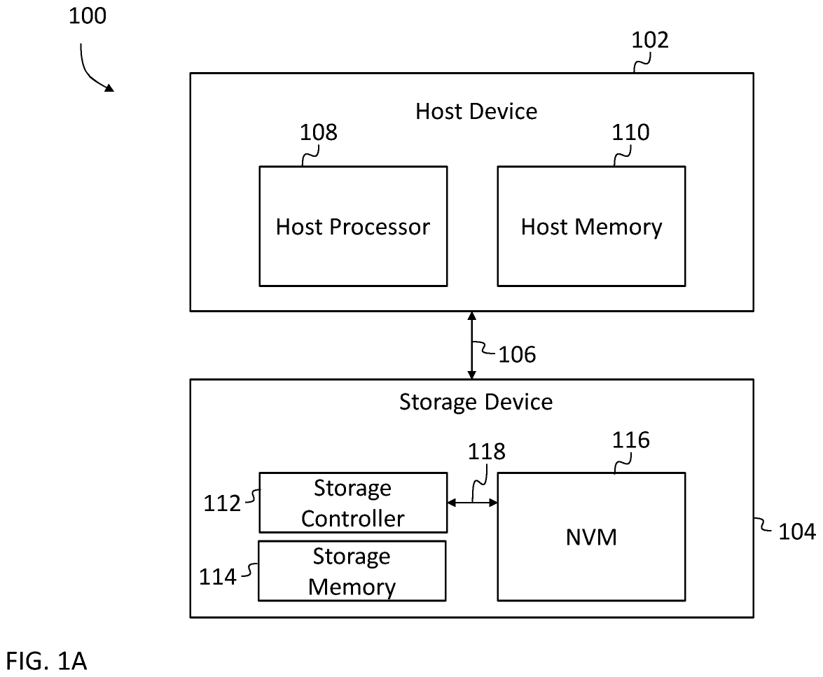

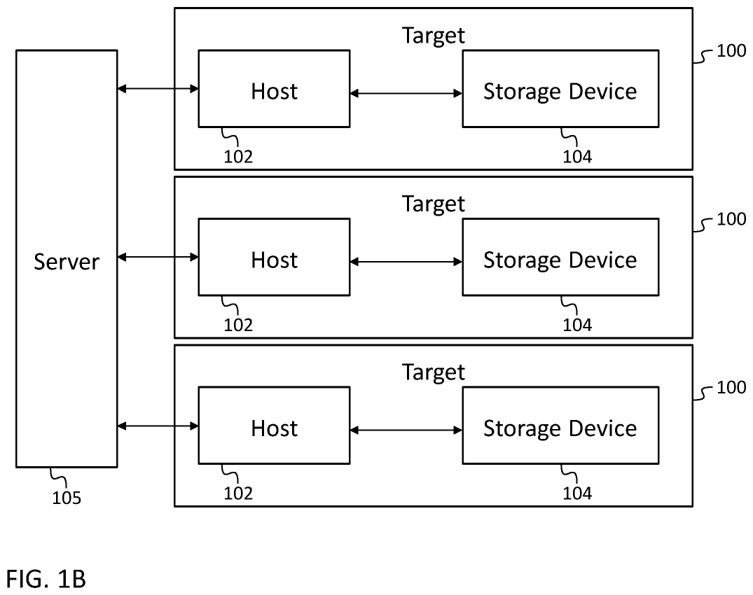

FIG. 1A illustrates a computing system, which may be referred to as a “target” 100, according to some embodiments of the present disclosure. Referring to FIG. 1A, the target 100 may include a host device 102 and a storage device 104 (which may be a nonvolatile storage device 104). In some embodiments, the host device 102 may be housed with the storage device 104, and in other embodiments, the host device 102 may be separate from the storage device 104. The host device 102 may include any suitable computing device connected to a storage device 104 such as, for example, a personal computer (PC), a portable electronic device, a hand-held device, a laptop computer, or the like. As discussed in further detail below, the host device 102 may include a host processor 108 which may implement a system and method for debugging using breakpoint bits. Such a system and method may be employed for debugging software executing on the host device 102, including software that may perform interfacing functions with the storage device 104.

The host device 102 may be connected to the storage device 104 over a host interface 106. The host device 102 may issue data request commands or input-output (IO) commands (for example, read or write commands) to the storage device 104 over the host interface 106, and may receive responses from the storage device 104 over the host interface 106.

The host device 102 may include a host processor 108 and host memory 110. The host processor 108 may be a processing circuit (discussed in further detail below), for example, such as a general-purpose processor or a central processing unit (CPU) core of the host device 102. The host processor 108 may be connected to other components via an address bus, a control bus, a data bus, or the like. The host memory 110 may be main memory (for example, primary memory) of the host device 102. For example, in some embodiments, the host memory 110 may include (or may be) volatile memory, for example, such as dynamic random-access memory (DRAM). However, the present disclosure is not limited thereto, and the host memory 110 may include (or may be) any suitable main memory (for example, primary memory) for the host device 102 as would be known to those skilled in the art. For example, in other embodiments, the host memory 110 may be relatively high performing non-volatile memory, such as NAND flash memory, Phase Change Memory (PCM), Resistive RAM, Spin-transfer Torque RAM (STTRAM), any suitable memory based on PCM technology, memristor technology, or resistive random access memory (ReRAM), and may include, for example, chalcogenides or the like.

The storage device 104 may operate as secondary memory that may persistently store data accessible by the host device 102. In this context, the storage device 104 may include relatively slower memory when compared to the relatively high performing memory of the host memory 110. For example, in some embodiments, the storage device 104 may be secondary memory of the host device 102, for example, such as a Solid-State Drive (SSD). However, the present disclosure is not limited thereto, and in other embodiments, the storage device 104 may include (or may be) any suitable storage device such as, for example, a magnetic storage device (for example, a hard disk drive (HDD), or the like), an optical storage device (for example, a Blue-ray disc drive, a compact disc (CD) drive, a digital versatile disc (DVD) drive, or the like), other kinds of flash memory devices (for example, a USB flash drive, and the like), or the like. In various embodiments, the storage device 104 may conform to a large form factor standard (for example, a 3.5-inch hard drive form-factor), a small form factor standard (for example, a 2.5 inch hard drive form-factor), an M.2 form factor, an E1.S form factor, or the like. In other embodiments, the storage device 104 may conform to any suitable or desired derivative of these form factors. For convenience, the storage device 104 may be described hereinafter in the context of a solid-state drive, but the present disclosure is not limited thereto.

The storage device 104 may be communicably connected to the host device 102 over the host interface 106. The host interface 106 may facilitate communications (for example, using a connector and a protocol) between the host device 102 and the storage device 104. In some embodiments, the host interface 106 may facilitate the exchange of storage requests (or “commands”) and responses (for example, command responses) between the host device 102 and the storage device 104. In some embodiments, the host interface 106 may facilitate data transfers by the storage device 104 to and from the host memory 110 of the host device 102. For example, in various embodiments, the host interface 106 (for example, the connector and the protocol thereof) may include (or may conform to) Small Computer System Interface (SCSI), Non Volatile Memory Express (NVMe), Peripheral Component Interconnect Express (PCIe), remote direct memory access (RDMA) over Ethernet, Serial Advanced Technology Attachment (SATA), Fiber Channel, Serial Attached SCSI (SAS), NVMe over Fabric (NVMe-oF), or the like. In other embodiments, the host interface 106 (for example, the connector and the protocol thereof) may include (or may conform to) various general-purpose interfaces, for example, such as Ethernet, Universal Serial Bus (USB), and/or the like.

In some embodiments, the storage device 104 may include a storage controller 112, storage memory 114 (which may also be referred to as a buffer), non-volatile memory (NVM) 116, and a storage interface 118. The storage memory 114 may be high-performing memory of the storage device 104, and may include (or may be) volatile memory, for example, such as DRAM, but the present disclosure is not limited thereto, and the storage memory 114 may be any suitable kind of high-performing volatile or non-volatile memory. The non-volatile memory 116 may persistently store data received, for example, from the host device 102. The non-volatile memory 116 may include, for example, NAND flash memory, but the present disclosure is not limited thereto, and the non-volatile memory 116 may include any suitable kind of memory for persistently storing the data according to an implementation of the storage device 104 (for example, magnetic disks, tape, optical disks, or the like).

The storage controller 112 may be connected to the non-volatile memory 116 over the storage interface 118. In the context of the SSD, the storage interface 118 may be referred to as flash channel, and may be an interface with which the non-volatile memory 116 (for example, NAND flash memory) may communicate with a processing component (for example, the storage controller 112) or other device. Commands such as reset, write enable, control signals, clock signals, or the like may be transmitted over the storage interface 118. Further, a software interface may be used in combination with a hardware element that may be used to test or verify the workings of the storage interface 118. The software may be used to read data from and write data to the non-volatile memory 116 via the storage interface 118. Further, the software may include firmware that may be downloaded onto hardware elements (for example, for controlling write, erase, and read operations).

The storage controller 112 (which may be a processing circuit (discussed in further detail below)) may be connected to the host interface 106, and may manage signaling over the host interface 106. In some embodiments, the storage controller 112 may include an associated software layer (for example, a host interface layer) to manage the physical connector of the host interface 106. The storage controller 112 may respond to input or output requests received from the host device 102 over the host interface 106. The storage controller 112 may also manage the storage interface 118 to control, and to provide access to and from, the non-volatile memory 116. For example, the storage controller 112 may include at least one processing component embedded therein for interfacing with the host device 102 and the non-volatile memory 116. The processing component may include, for example, a general purpose digital circuit (for example, a microcontroller, a microprocessor, a digital signal processor, or a logic device (for example, a field programmable gate array (FPGA), an application-specific integrated circuit (ASIC), or the like)) capable of executing data access instructions (for example, via firmware or software) to provide access to the data stored in the non-volatile memory 116 according to the data access instructions. For example, the data access instructions may correspond to the data request commands, and may include any suitable data storage and retrieval algorithm (for example, read, write, or erase) instructions, or the like.

FIG. 1B is a system-level diagram, in some embodiments. Within each target 100, a host 102 is connected to a nonvolatile storage device 104 (which may be, for example, a solid-state drive (SSD)). The nonvolatile storage device 104 may have (as discussed above) a form factor that is any one of a plurality of form factors suitable for nonvolatile storage devices, including but not limited to 2.5″, 1.8″, MO-297, MO-300, M.2, and Enterprise and Data Center SSD Form Factor (EDSFF), and it may have an electrical interface (which may be referred to as a “host interface”), through which it may be connected to the host 102, that is any one of a plurality of interfaces suitable for nonvolatile storage devices, including

Peripheral Component Interconnect (PCI), PCI express (PCIe), Ethernet, Small Computer

System Interface (SCSI), Serial AT Attachment (SATA), and Serial Attached SCSI (SAS) or Universal Flash Storage (UFS). The nonvolatile storage device 104 may include an interface circuit which operates as an interface adapter between the host interface 106 and one or more internal interfaces in the nonvolatile storage device 104.

The host interface may be used by the host 102 to communicate with the nonvolatile storage device 104, for example, by sending write and read commands, which may be received, by the nonvolatile storage device 104, through the host interface. The host interface may also be used by the nonvolatile storage device 104 to perform data transfers to and from system memory of the host 102.

Such data transfers may be performed using direct memory access (DMA). For example, when the host 102 sends a write command to the nonvolatile storage device 104, the nonvolatile storage device 104 may fetch the data to be written to the non-volatile memory 116 from the host memory 110 of the host device 102 using direct memory access, and the nonvolatile storage device 104 may then save the fetched data to the non-volatile memory 116. Similarly, if the host 102 sends a read command to the nonvolatile storage device 104, the nonvolatile storage device 104 may read the requested data (i.e., the data specified in the read command) from the non-volatile memory 116 and save it in the host memory 110 of the host device 102 using direct memory access. The nonvolatile storage device 104 may store data in a nonvolatile memory, for example, not-AND (NAND) flash memory, for example, in memory dies containing memory cells, each of which may be, for example, a Single-Level Cell (SLC), a Multi-Level Cell (MLC), or a Triple-Level Cell (TLC).

A Flash Translation Layer (FTL) (discussed in further detail below) of the nonvolatile storage device 104 may provide a mapping between logical addresses used by the host 102 and physical addresses of the data in the nonvolatile memory. The nonvolatile storage device 104 may also include (i) a buffer which may include (for example, consist of) dynamic random-access memory (DRAM), and (ii) a nonvolatile memory controller (for example, a flash controller) for providing suitable signals to the nonvolatile memory. Some or all of the host interface, the Flash Translation Layer, the buffer, and the nonvolatile memory controller may be implemented in a processing circuit, which may be referred to as the nonvolatile storage device controller.

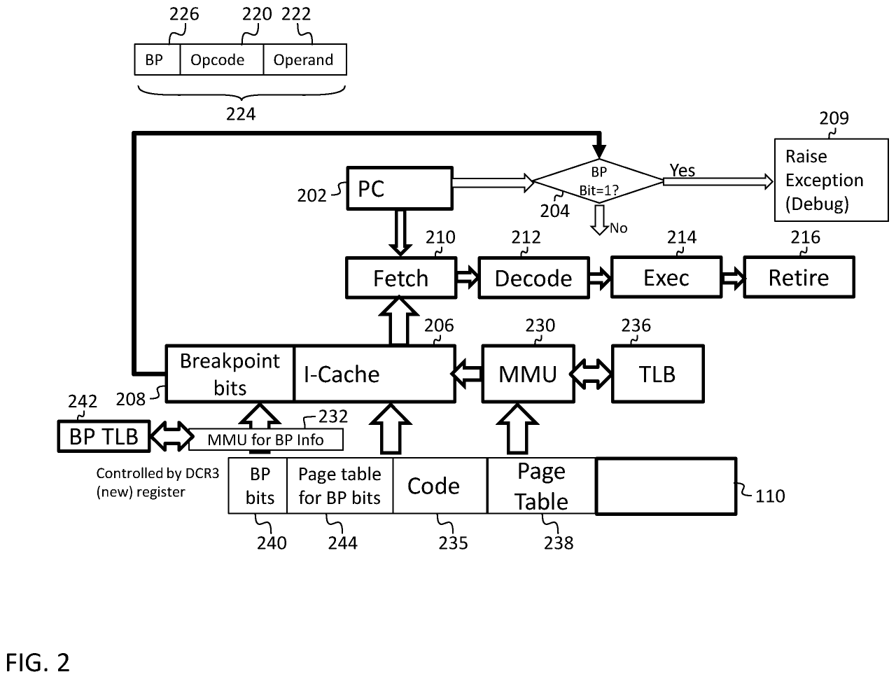

FIG. 2 depicts a hybrid block diagram and flow chart of the structure and operation of a portion of a host processor 108 (for example, a central processing unit), and of the host memory 110, in some embodiments. The host processor 108 includes a program counter (PC) 202, a breakpoint bit test circuit 204, an instruction cache 206, and a breakpoint bit cache 208. The host processor 108 may be or include a microprocessor chip which may be a silicon chip (for example, a single-crystal silicon substrate) on which circuits have been fabricated for performing the functions described herein. When an instruction is fetched, at 210, from the instruction cache 206, the corresponding breakpoint bit (BP bit) is loaded from the breakpoint bit cache 208. If the breakpoint bit loaded from the breakpoint bit cache 208 is set, then the breakpoint bit test circuit 204 causes the host processor 108 to report an error (for example to raise an exception), at 209. If the bit loaded from the breakpoint bit cache 208 is not set, then the breakpoint bit test circuit 204 does not cause the host processor 108 to raise an exception, and execution proceeds normally; the instruction may be decoded at 212, executed at 214, and retired at 216. As used herein, the breakpoint bit is “set” if it has a value that indicates that an exception is to be raised. The host processor 108 may be configured to interpret a value of one in the breakpoint bit to correspond to the bit being set, or the host processor 108 may be configured to interpret a value of zero in the breakpoint bit to correspond to the bit being set.

The instruction may include an opcode field 220 and an operand field 222. The operand field may include (for example, contain) an immediate operand (for example, a constant), an address of an operand, or an address of a pointer to an operand. A composite instruction word 224 may be formed by combining the instruction with a breakpoint bit 226. This composite instruction word 224 may be formed by a suitable data routing circuit and fed to (i) the breakpoint bit test circuit 204 and (ii) an instruction processing circuit of the host processor 108, or two or more of the elements of the composite instruction word 224 may be routed separately, with, for example, the breakpoint bit 226 being routed separately, from the breakpoint bit cache 208 to the breakpoint bit test circuit 204.

The breakpoint bit cache 208 and the instruction cache 206 may be part of a single memory, for example, the breakpoint bit cache 208 and the instruction cache 206 may be part of an array of static random access memory cells or of an array of dynamic random access memory cells with a single (shared) address bus and a single (shared) data bus. Such an array of memory cells may be configured as a level one cache. In other embodiments, the breakpoint bit cache 208 and the instruction cache 206 may each be implemented in a respective separate memory. For example, the instruction cache 206 may be implemented in a first array of static random access memory cells or of dynamic random access memory cells with an address bus and a data bus, and the breakpoint bit cache 208 may be implemented in a second array of static random access memory cells or of dynamic random access memory cells with an address bus and a data bus.

The instruction cache 206 and the breakpoint bit cache 208 may not be sufficiently large to store an entire program (for example, the entire piece of software being executed). As such, parts of the program (and the corresponding breakpoint bits 226) may be stored in the host memory 110 or in the nonvolatile storage device 104. A memory management unit (MMU) for instructions 230 may manage the movement of instructions between the host memory 110 and the instruction cache 206, and a memory management unit for breakpoint bits 232 may manage the movement of breakpoint bits between the host memory 110 and the breakpoint bit cache 208. For example, when the host processor 108 is ready to execute a new instruction, the host processor 108 may attempt to fetch the new instruction from the instruction cache 206; if the instruction is present in the instruction cache 206 (a circumstance that may be referred to as a “cache hit” or “instruction cache hit”) then the host processor 108 may fetch, at 210, the instruction from the instruction cache 206. The host processor 108 may similarly attempt to fetch the corresponding breakpoint bit 226 from the breakpoint bit cache 208; if the instruction is present in the breakpoint bit cache 208 (a circumstance that may be referred to as a “breakpoint bit cache hit”) then the host processor 108 may fetch the breakpoint bit 226 from the breakpoint bit cache 208 and forward it to the breakpoint bit test circuit 204.

If, when the host processor 108 attempts to fetch the new instruction from the instruction cache 206, the instruction is not present in the instruction cache 206 (a circumstance that may be referred to as a “cache miss” or “instruction cache miss”) then the memory management unit for instructions 230 may fetch one or more instructions from a code section 235 of the host memory 110 (or from the nonvolatile storage device 104, if the relevant page is not in the host memory 110). The memory management unit for instructions 230 may convert virtual addresses to physical addresses using a translation lookaside buffer (TLB) for instructions 236. The translation lookaside buffer (TLB) for instructions 236 may also be referred to as an address conversion cache for instructions. Complete address translation information for instructions may be stored in a page table for instructions 238 in the host memory 110, and the translation lookaside buffer for instructions 236 may cache portions of the page table for instructions 238.

Similarly if, when the host processor 108 attempts to fetch the corresponding breakpoint bit 226 from the breakpoint bit cache 208, the corresponding breakpoint bit 226 is not present in the breakpoint bit cache 208 (a circumstance that may be referred to as a “breakpoint bit cache miss”) then the memory management unit for breakpoint bits 232 may fetch one or more corresponding breakpoint bits 226 from a breakpoint bit section 240 of the host memory 110 (or from the nonvolatile storage device 104, if the relevant page is not in the host memory 110). The memory management unit for breakpoint bits 232 may convert virtual addresses to physical addresses using a translation lookaside buffer for breakpoint bits (BP TLB) 242. The translation lookaside buffer (TLB) for breakpoint bits may also be referred to as an address conversion cache for breakpoint bits. Complete address translation information for breakpoint bits 242 may be stored in a page table for breakpoint bits 244 in the host memory 110, and the translation lookaside buffer for breakpoint bits 242 may cache portions of the page table for breakpoint bits 244. The operating system may manage (i) the allocation of physical memory for the program and (ii) the corresponding page table. The operating system may also manage (i) the allocation of physical memory for the breakpoint bits and (ii) the corresponding page table, in a similar manner.

The interaction of the memory management unit for instructions 230 with the instruction cache 206 may be controlled by control register 3 (CR3), in some embodiments. Control register 3 may be used when the paging bit is set in control register 0, and virtual addressing is enabled. Similarly, a debug control register, for example, debug control register 3 (DCR3), may control the interaction of the memory management unit for breakpoint bits 232 with the breakpoint bit cache 208.

In some embodiments, the breakpoint bit cache 208 is managed so that whenever an instruction is in the instruction cache 206, the corresponding breakpoint bit 226 is in the breakpoint bit cache 208. This may be accomplished, for example, by fetching the corresponding breakpoint bits 226 into the breakpoint bit cache 208 whenever instructions are fetched from the host memory 110 (or from the nonvolatile storage device 104) into the instruction cache 206, and by evicting breakpoint bits 226 from the breakpoint bit cache 208 only when the corresponding instructions have been evicted from the instruction cache 206. In such an embodiment the breakpoint bit cache 208 may be sized to be sufficiently large to store the breakpoint bits 226 corresponding to all of the instructions in the instruction cache 206; because fetches of data from the host memory 110 may be performed in increments of one cache line, this constraint may mean that the breakpoint bit cache 208 may be significantly larger than if the caching of breakpoint bits 226 is managed independently of the caching of instructions.

In some embodiments, the memory management unit for breakpoint bits 232 is integrated with the memory management unit for instructions 230; for example, a single processing circuit may perform both the functions of the memory management unit for breakpoint bits 232 and of the memory management unit for instructions 230. In some embodiments, the breakpoint bits 226 are stored in the host memory 110 at locations (for example, at addresses) selected so that a single page table, for example, the page table for instructions 238, is sufficient to determine, for a given virtual address for an instruction, both (i) the physical address of the instruction and (ii) the physical address of the corresponding breakpoint bit. For example, the physical address of each breakpoint bit 226 may be related by an arithmetic expression to the physical address of the corresponding instruction. This may make it unnecessary to maintain a separate page table for breakpoint bits 244 and a separate translation lookaside buffer for breakpoint bits 242.

In some embodiments, the operating system of the computing system 100 may support the use of breakpoint bits. For example, when execution of a program is initiated (for example, by a user), the operating system may (i) instantiate a new process for the running of the program, (ii) load some or all of the executable code for the program into the host memory 110, (iii) load some or all of the breakpoint bits for the program into the host memory 110, and (iv) set the relevant control parameters in a process control block maintained, for the process, by the operating system. These control parameters may include a parameter indicating that the breakpoint bits are to be used to trigger exceptions when set. In such an embodiment, it may not be necessary to recompile the program to change the breakpoints; instead (i) several breakpoint bit files may be generated at compile time, one of which may be selected for use, at run time, or (ii) the breakpoint bit file may be generated at run time based on information (for example, information generated at compile time) specifying where the breakpoint bit for each instruction in the executable code is stored in a breakpoint bit file or array.

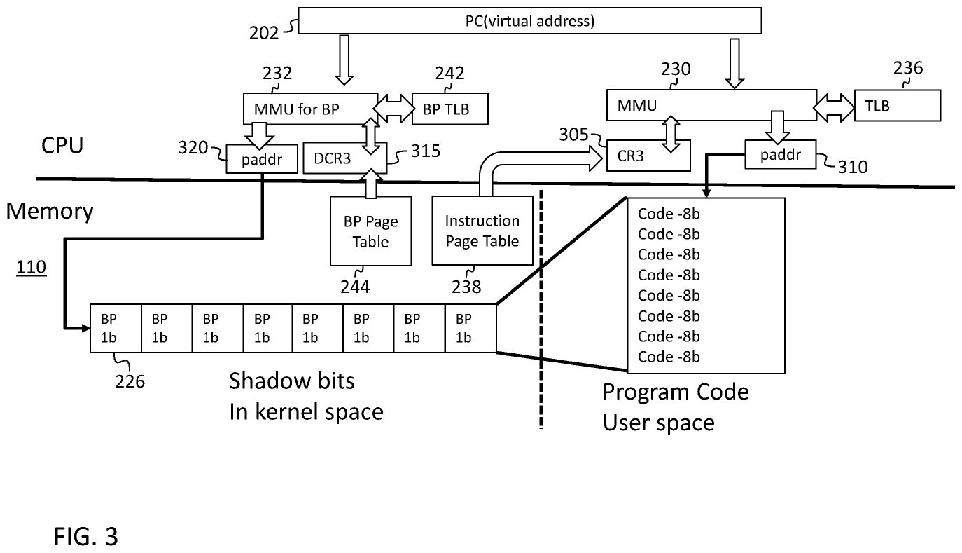

FIG. 3 depicts the storage and management of breakpoint bits 226 and instructions, in some embodiments. The instructions (for example, program code) may be stored in user space in the host memory 110, and the breakpoint bits 226 may be stored as shadow bits in kernel space in the host memory 110. Shadow bits may be disjoint metadata for program code (that are managed by the operating system and transparent to the program); 1 byte of program code may correspond to 1 shadow bit in the shadow memory region, which may be invisible to the program. Under the control of a control register 305 (for example, CR3), which may indicate that virtual addressing is enabled, the memory management unit for instructions 230 reads, from the program counter 202, the virtual address of the instruction to be executed, and determines the corresponding physical address 310 using the translation lookaside buffer for instructions 236. If the corresponding address is not in the instruction cache 206 (FIG. 2) then it is fetched from the host memory 110. Similarly, under the control of a control register 315 (for example, DCR3), which may indicate that breakpoints are enabled, the memory management unit for breakpoint bits 232 reads, from the program counter 202, the virtual address of the breakpoint bit 226 for the instruction to be executed, and determines the corresponding physical address 320 of the breakpoint using the translation lookaside buffer for breakpoint bits 242. If the corresponding address is not in the breakpoint bit cache 208 (FIG. 2) then it is fetched from the host memory 110. Both the page table for instructions 238 and the page table for breakpoint bits 244, portions of which are cached by the translation lookaside buffer for instructions 236 and by the translation lookaside buffer for breakpoint bits 242 respectively, may be stored in the host memory 110. FIG. 3 shows eight instruction bytes in the program code space of the host memory 110 and the corresponding eight breakpoint bits 226 in kernel space in the host memory 110. In some embodiments, a breakpoint bit 226 is present for each instruction. In some embodiments, a breakpoint bit 226 may be present for each instruction byte. This may result in several breakpoint bits 226 being present for each instruction. These breakpoint bits 226 corresponding to one instruction may signal a breakpoint for the instruction if, e.g., (i) any of the breakpoint bits 226 are set, (ii) all of the breakpoint bits 226 are set, or, (iii) a particular breakpoint bit 226 (e.g., the most significant bit or the least significant bit) is set.

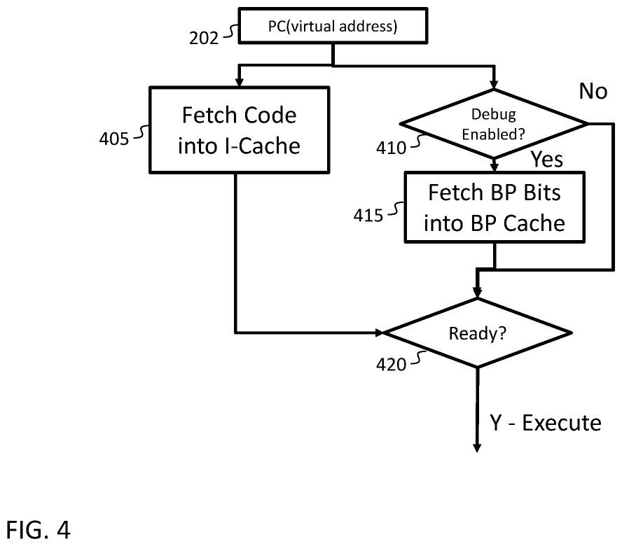

FIG. 4 is a flow chart of a method for responding to debug bit enablement, in some embodiments. A value of the program counter 202 (which may be a virtual address) is used, at 405, to fetch code into the instruction cache 206. At 410, it is determined (for example, based on a debug control register (for example, based on DCR3)) whether debugging is enabled; if it is, then at 415, breakpoint bits 226 are fetched into the breakpoint bit cache 208; otherwise, the breakpoint bits 226 are not fetched into the breakpoint bit cache 208. At 420, it is determined whether the system is ready to begin execution, and, if it is, execution begins.

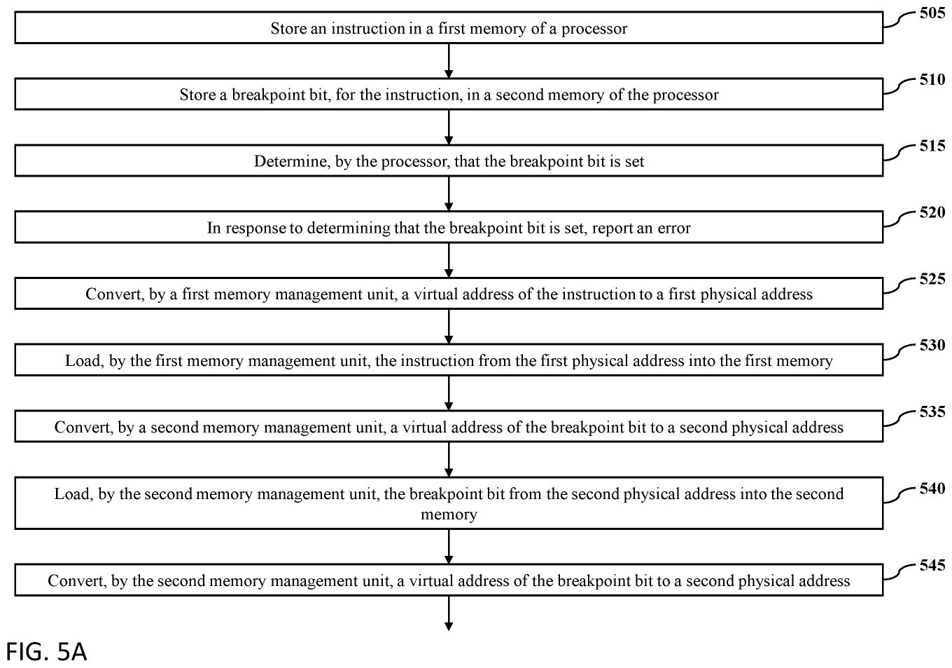

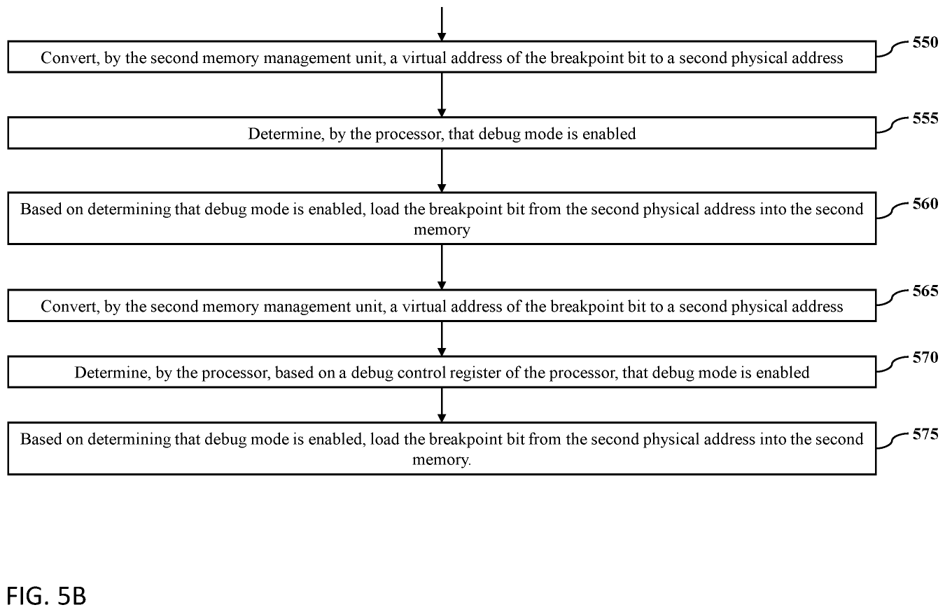

FIGS. 5A and 5B are, together, a flow chart of a method (which continues from FIG. 5A to FIG. 5B), in some embodiments. The method includes, storing, at 505, an instruction in a first memory of a processor; storing, at 510, a breakpoint bit, for the instruction, in a second memory of the processor; determining, at 515, by the processor, that the breakpoint bit is set; in response to determining that the breakpoint bit is set, reporting, at 520, an error; converting, at 525, by a first memory management unit, a virtual address of the instruction to a first physical address; loading, at 530, by the first memory management unit, the instruction from the first physical address into the first memory; converting, at 535, by a second memory management unit, a virtual address of the breakpoint bit to a second physical address; loading, at 540, by the second memory management unit, the breakpoint bit from the second physical address into the second memory; converting, at 545, by the second memory management unit, a virtual address of the breakpoint bit to a second physical address; converting, at 550, by the second memory management unit, a virtual address of the breakpoint bit to a second physical address; determining, at 555, by the processor, that debug mode is enabled; based on determining that debug mode is enabled, loading, at 560, the breakpoint bit from the second physical address into the second memory; converting, at 565, by the second memory management unit, a virtual address of the breakpoint bit to a second physical address; determining, at 570, by the processor, based on a debug control register of the processor, that debug mode is enabled; and based on determining that debug mode is enabled, loading, at 575, the breakpoint bit from the second physical address into the second memory.

As used herein, “a portion of” something means “at least some of” the thing, and as such may mean less than all of, or all of, the thing. As such, “a portion of” a thing includes the entire thing as a special case, i.e., the entire thing is an example of a portion of the thing. As used herein, when a second quantity is “within Y” of a first quantity X, it means that the second quantity is at least X-Y and the second quantity is at most X+Y. As used herein, when a second number is “within Y %” of a first number, it means that the second number is at least (1−Y/100) times the first number and the second number is at most (1+Y/100) times the first number. As used herein, the term “or” should be interpreted as “and/or”, such that, for example, “A or B” means any one of “A” or “B” or “A and B”.

The background provided in the Background section of the present disclosure section is included only to set context, and the content of this section is not admitted to be prior art. Any of the components or any combination of the components described (e.g., in any system diagrams included herein) may be used to perform one or more of the operations of any flow chart included herein. Further, (i) the operations are example operations, and may involve various additional steps not explicitly covered, and (ii) the temporal order of the operations may be varied.

Each of the terms “processing circuit” and “means for processing” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

As used herein, when a method (e.g., an adjustment) or a first quantity (e.g., a first variable) is referred to as being “based on” a second quantity (e.g., a second variable) it means that the second quantity is an input to the method or influences the first quantity, e.g., the second quantity may be an input (e.g., the only input, or one of several inputs) to a function that calculates the first quantity, or the first quantity may be equal to the second quantity, or the first quantity may be the same as (e.g., stored at the same location or locations in memory as) the second quantity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed herein could be termed a second element, component, region, layer or section, without departing from the spirit and scope of the inventive concept.

The terminology used herein is for the purpose of describing particular embodiments only and is not intended to be limiting of the inventive concept. As used herein, the terms “substantially,” “about,” and similar terms are used as terms of approximation and not as terms of degree, and are intended to account for the inherent deviations in measured or calculated values that would be recognized by those of ordinary skill in the art.

As used herein, the singular forms “a” and “an” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present disclosure”. Also, the term “exemplary” is intended to refer to an example or illustration. As used herein, the terms “use,” “using,” and “used” may be considered synonymous with the terms “utilize,” “utilizing,” and “utilized,” respectively.

It will be understood that when an element or layer is referred to as being “on”, “connected to”, “coupled to”, or “adjacent to” another element or layer, it may be directly on, connected to, coupled to, or adjacent to the other element or layer, or one or more intervening elements or layers may be present. In contrast, when an element or layer is referred to as being “directly on”, “directly connected to”, “directly coupled to”, or “immediately adjacent to” another element or layer, there are no intervening elements or layers present.

Any numerical range recited herein is intended to include all sub-ranges of the same numerical precision subsumed within the recited range. For example, a range of “1.0 to 10.0” or “between 1.0 and 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Similarly, a range described as “within 35% of 10” is intended to include all subranges between (and including) the recited minimum value of 6.5 (i.e., (1−35/100) times 10) and the recited maximum value of 13.5 (i.e., (1+35/100) times 10), that is, having a minimum value equal to or greater than 6.5 and a maximum value equal to or less than 13.5, such as, for example, 7.4 to 10.6. Any maximum numerical limitation recited herein is intended to include all lower numerical limitations subsumed therein and any minimum numerical limitation recited in this specification is intended to include all higher numerical limitations subsumed therein.

It will be understood that when an element is referred to as being “directly connected” or “directly coupled” to another element, there are no intervening elements present. As used herein, “generally connected” means connected by an electrical path that may contain arbitrary intervening elements, including intervening elements the presence of which qualitatively changes the behavior of the circuit. As used herein, “connected” means (i) “directly connected” or (ii) connected with intervening elements, the intervening elements being ones (e.g., low-value resistors or inductors, or short sections of transmission line) that do not qualitatively affect the behavior of the circuit.

Some embodiments may include features of the following numbered statements.

1. A system, comprising:
a processor,
the processor comprising:
   a first memory configured to store an instruction; and
   a second memory configured to store a breakpoint bit, for the instruction, the processor being configured to:
   determine that the breakpoint bit is set, and
   based on determining that the breakpoint bit is set, to report an error.

2. The system of statement 1, wherein the first memory comprises a first portion of a level one cache, and the second memory comprises a second portion of the level one cache.

3. The system of statement 1 or statement 2, wherein the processor comprises a first memory management unit configured to:
convert a virtual address of the instruction to a first physical address; and
load the instruction from the first physical address into the first memory.

4. The system of any one of the preceding statements, wherein the processor comprises a second memory management unit configured to:
convert a virtual address of the breakpoint bit to a second physical address; and
load the breakpoint bit from the second physical address into the second memory.

5. The system of any one of the preceding statements, wherein:
the processor comprises a second memory management unit configured to convert a virtual address of the breakpoint bit to a second physical address;
the processor comprises an address conversion cache for breakpoint bits; and
the converting of the virtual address of the breakpoint bit to the second physical address comprises converting the virtual address of the breakpoint bit to the second physical address based on data stored in the address conversion cache for breakpoint bits.

6. The system of any one of the preceding statements, wherein:
the processor comprises a second memory management unit configured to convert a virtual address of the breakpoint bit to a second physical address; and
the processor is further configured to:
   determine that debug mode is enabled; and
based on determining that debug mode is enabled, load the breakpoint bit from the second physical address into the second memory.

7. The system of any one of the preceding statements, wherein:
the processor comprises a second memory management unit configured to convert a virtual address of the breakpoint bit to a second physical address; and
the processor is further configured to:
   determine, based on a debug control register of the processor, that debug mode is enabled; and
based on determining that debug mode is enabled, load the breakpoint bit from the second physical address into the second memory.

8. A method, comprising:
storing an instruction in a first memory of a processor;
storing a breakpoint bit, for the instruction, in a second memory of the processor;
determining, by the processor, that the breakpoint bit is set; and
in response to determining that the breakpoint bit is set, reporting an error.

9. The method of statement 8, wherein the first memory is a first portion of a level one cache, and the second memory is a second portion of the level one cache.

10. The method of statement 8 or statement 9, wherein the processor comprises a first memory management unit, and the method further comprises:
converting, by the first memory management unit, a virtual address of the instruction to a first physical address; and
loading, by the first memory management unit, the instruction from the first physical address into the first memory.

11. The method of any one of statements 8 to 10, wherein the processor comprises a second memory management unit, and the method further comprises:
converting, by the second memory management unit, a virtual address of the breakpoint bit to a second physical address; and
loading, by the second memory management unit, the breakpoint bit from the second physical address into the second memory.

12. The method of any one of statements 8 to 11, wherein:
the processor comprises a second memory management unit;
the method further comprises converting, by the second memory management unit, a virtual address of the breakpoint bit to a second physical address;
the processor comprises an address conversion cache for breakpoint bits; and
the converting of the virtual address of the breakpoint bit to the second physical address comprises converting the virtual address of the breakpoint bit to the second physical address based on data stored in the address conversion cache for breakpoint bits.

13. The method of any one of statements 8 to 12, wherein:
the processor comprises a second memory management unit; and
the method further comprises:
   converting, by the second memory management unit, a virtual address of the breakpoint bit to a second physical address;
   determining, by the processor, that debug mode is enabled; and
   based on determining that debug mode is enabled, loading the breakpoint bit from the second physical address into the second memory.

14. The method of any one of statements 8 to 13, wherein:
the processor comprises a second memory management unit; and
the method further comprises:
   converting, by the second memory management unit, a virtual address of the breakpoint bit to a second physical address;
   determining, by the processor, based on a debug control register of the processor, that debug mode is enabled; and
   based on determining that debug mode is enabled, loading the breakpoint bit from the second physical address into the second memory.

15. A system, comprising:
a processing circuit; and
a memory,
wherein:
   the memory stores:
      an instruction; and
      a breakpoint bit, for the instruction; and
   the processing circuit is configured to:
      determine that the breakpoint bit is set, and
      in response to determining that the breakpoint bit is set, to report an error.

16. The system of statement 15, wherein the memory is a level one cache.

17. The system of statement 15 or statement 16, wherein the processing circuit comprises a first memory management unit configured to:
convert a virtual address of the instruction to a first physical address; and
load the instruction from the first physical address into the memory.

18. The system of any one of statements 15 to 17, wherein the processing circuit comprises a second memory management unit configured to:
convert a virtual address of the breakpoint bit to a second physical address; and
load the breakpoint bit from the second physical address into the memory.

19. The system of any one of statements 15 to 18, wherein:
the processing circuit comprises a second memory management unit configured to convert a virtual address of the breakpoint bit to a second physical address;
the processing circuit comprises an address conversion cache for breakpoint bits; and
the converting of the virtual address of the breakpoint bit to the second physical address comprises converting the virtual address of the breakpoint bit to the second physical address based on data stored in the address conversion cache for breakpoint bits.

20. The system of any one of statements 15 to 19, wherein:
the processing circuit comprises a second memory management unit configured to convert a virtual address of the breakpoint bit to a second physical address; and
the processing circuit is further configured to:
   determine that debug mode is enabled; and
based on determining that debug mode is enabled, load the breakpoint bit from the second physical address into the memory.

Although exemplary embodiments of systems and methods for debugging have been specifically described and illustrated herein, many modifications and variations will be apparent to those skilled in the art. Accordingly, it is to be understood that systems and methods for debugging constructed according to principles of this disclosure may be embodied other than as specifically described herein. The invention is also defined in the following claims, and equivalents thereof.

What is claimed is:

1. A system, comprising:
a processor,
the processor comprising:
a first memory configured to store an instruction; and
a second memory configured to store a breakpoint bit, for the instruction, the processor being configured to:
determine that the breakpoint bit is set, and
based on determining that the breakpoint bit is set, to report an error.

2. The system of claim 1, wherein the first memory comprises a first portion of a level one cache, and the second memory comprises a second portion of the level one cache.

3. The system of claim 1, wherein the processor comprises a first memory management unit configured to:
convert a virtual address of the instruction to a first physical address; and
load the instruction from the first physical address into the first memory.

4. The system of claim 1, wherein the processor comprises a second memory management unit configured to:
convert a virtual address of the breakpoint bit to a second physical address; and
load the breakpoint bit from the second physical address into the second memory.

5. The system of claim 1, wherein:
the processor comprises a second memory management unit configured to convert a virtual address of the breakpoint bit to a second physical address;
the processor comprises an address conversion cache for breakpoint bits; and
the converting of the virtual address of the breakpoint bit to the second physical address comprises converting the virtual address of the breakpoint bit to the second physical address based on data stored in the address conversion cache for breakpoint bits.

6. The system of claim 1, wherein:
the processor comprises a second memory management unit configured to convert a virtual address of the breakpoint bit to a second physical address; and
the processor is further configured to:
determine that debug mode is enabled; and
based on determining that debug mode is enabled, load the breakpoint bit from the second physical address into the second memory.

7. The system of claim 1, wherein:
the processor comprises a second memory management unit configured to convert a virtual address of the breakpoint bit to a second physical address; and
the processor is further configured to:
determine, based on a debug control register of the processor, that debug mode is enabled; and
based on determining that debug mode is enabled, load the breakpoint bit from the second physical address into the second memory.

8. A method, comprising:
storing an instruction in a first memory of a processor;
storing a breakpoint bit, for the instruction, in a second memory of the processor;
determining, by the processor, that the breakpoint bit is set; and
in response to determining that the breakpoint bit is set, reporting an error.

9. The method of claim 8, wherein the first memory is a first portion of a level one cache, and the second memory is a second portion of the level one cache.

10. The method of claim 8, wherein the processor comprises a first memory management unit, and the method further comprises:
converting, by the first memory management unit, a virtual address of the instruction to a first physical address; and
loading, by the first memory management unit, the instruction from the first physical address into the first memory.

11. The method of claim 8, wherein the processor comprises a second memory management unit, and the method further comprises:
converting, by the second memory management unit, a virtual address of the breakpoint bit to a second physical address; and
loading, by the second memory management unit, the breakpoint bit from the second physical address into the second memory.

12. The method of claim 8, wherein:
the processor comprises a second memory management unit;
the method further comprises converting, by the second memory management unit, a virtual address of the breakpoint bit to a second physical address;
the processor comprises an address conversion cache for breakpoint bits; and
the converting of the virtual address of the breakpoint bit to the second physical address comprises converting the virtual address of the breakpoint bit to the second physical address based on data stored in the address conversion cache for breakpoint bits.

13. The method of claim 8, wherein:
the processor comprises a second memory management unit; and
the method further comprises:
converting, by the second memory management unit, a virtual address of the breakpoint bit to a second physical address;
determining, by the processor, that debug mode is enabled; and
based on determining that debug mode is enabled, loading the breakpoint bit from the second physical address into the second memory.

14. The method of claim 8, wherein:
the processor comprises a second memory management unit; and
the method further comprises:
converting, by the second memory management unit, a virtual address of the breakpoint bit to a second physical address;
determining, by the processor, based on a debug control register of the processor, that debug mode is enabled; and
based on determining that debug mode is enabled, loading the breakpoint bit from the second physical address into the second memory.

15. A system, comprising:
a processing circuit; and
a memory,
wherein:
the memory stores:
an instruction; and
a breakpoint bit, for the instruction; and
the processing circuit is configured to:
determine that the breakpoint bit is set, and
in response to determining that the breakpoint bit is set, to report an error.

16. The system of claim 15, wherein the memory is a level one cache.

17. The system of claim 15, wherein the processing circuit comprises a first memory management unit configured to:
convert a virtual address of the instruction to a first physical address; and
load the instruction from the first physical address into the memory.

18. The system of claim 15, wherein the processing circuit comprises a second memory management unit configured to:
convert a virtual address of the breakpoint bit to a second physical address; and
load the breakpoint bit from the second physical address into the memory.

19. The system of claim 15, wherein:
the processing circuit comprises a second memory management unit configured to convert a virtual address of the breakpoint bit to a second physical address;
the processing circuit comprises an address conversion cache for breakpoint bits; and
the converting of the virtual address of the breakpoint bit to the second physical address comprises converting the virtual address of the breakpoint bit to the second physical address based on data stored in the address conversion cache for breakpoint bits.

20. The system of claim 15, wherein:
the processing circuit comprises a second memory management unit configured to convert a virtual address of the breakpoint bit to a second physical address; and
the processing circuit is further configured to:
determine that debug mode is enabled; and
based on determining that debug mode is enabled, load the breakpoint bit from the second physical address into the memory.
